(19) United States
(12) Patent Application Publication
(10) Pub. No.: US 2011/0116996 A1
(43) Pub. Date: May 19, 2011

(54) PROCESS FOR NON-HEATING LEACHING NICKEL AND MAGNESIUM FROM LATERITE USING MECHANO-CHEMICAL EFFECT

(76) Inventors: Sang-Bae Kim, Daejeon (KR); Wan-Tae Kim, Daejeon (KR)

(21) Appl. No.: 12/645,401

(22) Filed: Dec. 22, 2009

(30) Foreign Application Priority Data
Nov. 19, 2009 (KR) 10-2009-0112136

(51) Int. Cl. C22B 1/14; C01G 53/00

(52) U.S. Cl. 423/150.1

(57) ABSTRACT

A method of physicochemical leaching valuable metals is able to increase the leaching rate of nickel and magnesium contained in laterites, nickel ores, with a low concentration acid solution by using mechano-chemical effect. That is a method to add external energy to laterites containing nickel and magnesium to physically disintegrate their crystals and exposure nickels captured inside of the crystals to leach nickel and magnesium with a low concentration acid solution. It is a useful method to solve conventional problems such as the high energy cost of pyrometallurgical treatment and excessive use of strong acids of hydrometallurgical method.

### CROSS-REFERENCE TO RELATED APPLICATION(S)

This application claims priority to and the benefit of Korean Application No. 10-2009-0112136, filed on Nov. 19, 2009, in the Korean Intellectual Property Office, the entire content of which is incorporated herein by reference.

### DETAILED DESCRIPTION

1. Technical Field

The present invention relates to a method of physicochemical leaching valuable metals able to increase the leaching rate of nickel (Ni) and magnesium (Mg) contained in laterites, nickel ores, with a low concentration acid solution by using mechano-chemical effect.

2. Background Art

Nickel (Ni), one of the silver-white metal elements, is a rare mineral occurring in nature and having similar malleability and ductility to iron (Fe), better anti-corrodibility against air, water, base, and etc. than iron, and ferromagnetism, but small resources. It is used in stainless steels, heat resistant steels, nickel alloys, electroplates, ally steels, batteries, catalysts, cast irons, chemical agents, etc., and known as a quite important metal in industry.

Magnesium (Mg) is one of the silver-white light metal elements, well dissolving in acid to generate hydrogen, having good malleability, existing in nature as the form of such like carbonates, sulfates, and silicates in ores, sea water, mineral water, or inside of fauna and flora, and generally obtained by electrolysis of brine. It is used in camera flashes, getters, heat insulators, reducing agents, and electric anti-corrosion devices, and as a strong structural material, the demand is rapidly increasing because of its plasticity and lightness.

Meanwhile, because nickel ores are generally known having a extremely low nickel content, recently, developing technologies for the efficient recovery of nickel attracts attention.

The technology of nickel ore treatment is mainly divided into pyrometallurgical treatment producing ferronickel through melting process in high temperature furnaces and hydrometallurgical treatment isolating nickel metals by using strong acid solutions such like sulfuric acid. Process for enriching nickel by physical methods is being studied in many developed countries, but a notable result has not yet been achieved. Therefore, the hydrometallurgical treatment, a chemical method, is adopted in almost nickel recovery plants.

While pyrometallurgical treatment is a limited method only able to apply certain ores consisting of a fixed ratio of iron and nickel to forming ferronickel in melting process, hydrometallurgical treatment is a method isolating and recovering nickel and other valuable metals by selective or entire dissolution of metal, employs a long time deposition in hydrochloric acid or sulfuric acid in high concentration, or heating to increase efficiency.

As conventional technologies, Korea Patent No. 2009-49078 presents increase of leach rate or reduction of leach time by applying acid solutions like sulfuric acid at 70° C. or boiling point, or maintenance of high pressure around leaching area, U.S. Pat. No. 4,044,096 provides a guideline to optimize high pressure acid leaching of nickel-containing laterite ores by the combination of process to advance leach rate and economical efficiency, and Korea Patent No. 1989-2035 describes method(electrolytic method) for leaching nickel by electrolysis initiated with sulfurous gas injection into an anode chamber of an electrolytic cell containing ores at anode chamber and sulfuric acid at cathode chamber. Almost technologies directly leach law ores with inorganic acids like sulfuric acid and they have, as mentioned earlier, disadvantages of requiring concentrated acid, high temperature or high pressure to increase leach rate and reduce leach time because target nickel and magnesium are captured inside of mineral lattices.

Meanwhile, nickel contained in mineral is known hardly able to be physically isolated from other components because of its rarity and distribution among inside of the mineral lattices. In order to recover pure nickel, it is widely carried out to deposit ores long time in strong acid solutions like hydrochloric acid or sulfuric acid at high concentration and it is general to add heating to increase leach rate. Because there are a lot of economical and environmental problems such as reagent cost and wastewater treatment problem caused by the usage of a large amount of acid solutions and energy cost for heating, it is essential to take measures to reduce investment and prevent environmental pollution.

### PROBLEMS TO BE SOLVED BY EMBODIMENT OF THE INVENTION

The present invention is devised to solve the problems of treatment cost and environmental issue described in the above, and object of the invention is to provide a method for adding external energy to particles containing nickel and magnesium to physically disintegrate crystals of nickel ores and exposure nickel on surface to leach nickel and magnesium with a low concentration acid solution to significantly reduce reagent cost, wastewater treatment cost, and energy cost, and enable environmental friendly leaching valuable metals.

### MEANS FOR SOLVING THE PROBLEMS

The present invention is to provide a method of leaching products gained after crushing and grinding of laterite ores, comprising steps of crushing the ores into about 3 mm particles by using a jaw crusher and a cone crusher, grinding small particles in a mill for a certain time after size separation of above particles, and stirring and leaching above small particles after acid application, leaching nickel and magnesium from laterite ores.

### EFFECT OF THE EMBODIMENT OF THE INVENTION

The method of the present invention is advantageous in that, by combining of physicochemical methods comprising steps of using mechano-chemical effect applying strong external physical energy to nickel-containing particles to disintegrate their crystal to expose their surface and leaching nickel and magnesium with acid solutions at low concentration in room temperature without heating, pollution sources and production costs can be reduced to eco-friendly improve economical efficiency.

### BRIEF DESCRIPTION OF THE DRAWING

FIG. 1 is a process flow diagram illustrating the method of the present invention.

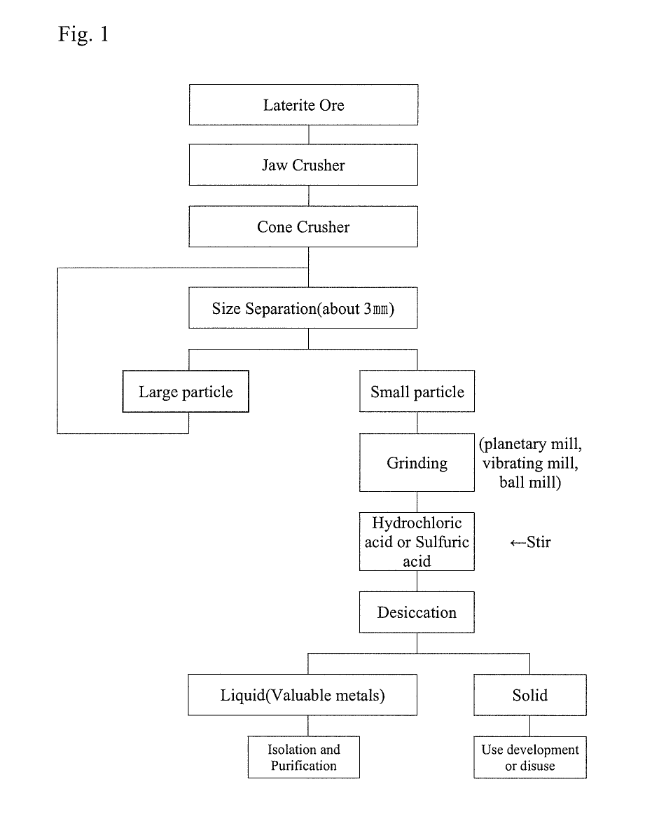

### MODE FOR CARRYING OUT EMBODIMENT OF THE INVENTION

The present invention, technical composition and operation for recovery of nickel and magnesium from laterite ores, can be explained in detail with attached drawings as follows.

At first, by a jaw crusher and a cone crusher, raw ores are crushed into about 3 mm, and crushed ores are applied to a planetary mill, a vibrating mill, or a ball mill to be grinned in a certain time. Because the grinding time depends on types of mills and size and density of the media used in grinding, it is hard to mention uniformity. According to the type of the grinder, grind ores until the laterite crystals are disintegrated. The degree of disintegration of particle can be confirmed with X-ray diffraction analysis. After deposition of disintegrated particles in hydrochloric acid or sulfuric acid and stir for 1 hour with stirrer, nickel and magnesium can be obtained as a solution phase when the solid and the liquid are separated. At this time, the higher concentration hydrochloric acid or sulfuric acid has, the higher leaching rate is, but good leaching rate can be achieved at around 0.5N.

Meanwhile, because few silicon and iron are leached in the solution, separation process is required to remove them. After stirring and solid-liquid separation by a dehydrator, solid is wasted or used by development other usage, and liquid is applied to isolation and purification process to separate and recover valuable metals like nickel and magnesium.

It can be explained in detail with fallowing examples.

### EXAMPLES

The contents of main component of the ore used in the experiment for the present invention were Ni 1.65%, MgO 20.05%, SiO₂ 36.60%, Fe₂O₃ 20.99%, as shown in Table 1.

TABLE 1
Components of Raw Ores

| Components | SiO₂ | Fe₂O₃ | MgO | Ni | Co | Others |
|---|---|---|---|---|---|---|
| Percentage | 36.60 | 20.99 | 20.05 | 1.65 | 0.06 | 20.65 |
| (wt) | | | | | | |

Because grinding time, kind and concentration of acid, and leaching time are thought to be factors having influence on the leach, by varying the grinding time, with hydrochloric acid and sulfuric acid, result of leach is presented. With a planetary mill, grinding was achieved for 5, 10, 30, and 60 minutes. The concentration of acid was fixed at 0.5N and the leaching time was also fixed for 1 hour. Analysis results of leaching rate of each component is shown in Table 2. When the grinding time was extended, the same results could be achieved with a ball mill and a vibrating mill.

Among each component contained in a laterite ore, leach rates of nickel and magnesium having high economic value are introduced. The leach rate was calculated by weight ratio, and the grinding times were raw ore status (grinding time 0), 5, 10, 15, 30, and 60 minutes. Used acid solutions were hydrochloric acid and sulfuric acid. The concentration was fixed at 0.5N and after 1 hour stirring with a stirrer, the solution was placed until the supernatant looks clear, followed by solid-liquid separation. The Leaching rate was calculated by subtraction of leaching result of raw ore from chemical analysis of the separated liquid.

TABLE 2
Leach Rate of Each Component in the Present Invention

| Grinding Time(min) | | 0 | 5 | 15 | 30 | 60 |
|---|---|---|---|---|---|---|
| 0.5N | Si | 8.7 | 12.4 | 14.8 | 19.5 | 23.8 |
| HCl | Fe | 10.0 | 21.1 | 31.0 | 40.5 | 45.1 |
| | Mg | 9.1 | 43.1 | 72.1 | 91.0 | 94.8 |
| | Ni | 8.2 | 45.5 | 65.0 | 87.7 | 92.1 |
| | Co | 14.4 | 41.1 | 55.3 | 71.6 | 86.4 |
| 0.5N | Si | 13.1 | 11.5 | 14.4 | 20.3 | 25.1 |
| H₂SO₄ | Fe | 14.6 | 23.1 | 32.6 | 39.2 | 43.8 |
| | Mg | 15.0 | 52.5 | 77.3 | 89.0 | 94.0 |
| | Ni | 17.3 | 53.7 | 70.5 | 88.0 | 91.2 |
| | Co | 18.1 | 41.4 | 59.8 | 68.6 | 77.3 |

[symbol]

The unit of leach rate is wt %, and leaching time is 1 hour.

In the results of leaching a raw ore, which was not ground, deposited in hydrochloric acid and sulfuric acid for 1 hour, the leaching rates of nickel were 8.2% and 17.3%, respectively, and the leaching rates of magnesium were 9.1% and 15.0%, respectively. Because nickel and magnesium were not exposed on surface, leach was hardly occurred. As the grinding progresses, in other words, disintegration of laterite crystal occurs, the leaching rates of nickel an magnesium were increased. When the laterite ore was ground for 1 hour and leached at the same condition with hydrochloric acid, the leaching rate of nickel was 92.1% and that of magnesium was increased to 94.8%.

At the same condition with sulfuric acid, leaching rate of nickel was 91.2% and that of magnesium was 94.0%, which showed almost nickel and magnesium were leached. Addition of physical energy to nickel-containing particles fallowed by leaching with acid at a low concentration enables recovery of nickel and magnesium with great reach rates.

### Comparison Examples

The overall comparison of properties between the present invention applying mechano-chemical effect and using acid solution at low concentration to efficiently recover nickel and magnesium from laterite ores, physical separation, and hydrometallurgical method is shown in Table 3.

TABLE 3
The Comparison of Properties between each Method

| | | | Recovery of |
|---|---|---|---|
| | Energy Input | Pollutant Loading | Valuable Metals |
| Present Invention | Small | Small | High |
| Physical | Very Small | Small | Very Low |
| Separation | | | |
| Hydrometallurgical | Small | Large | High |
| Method | | | |

As the comparison of the results, the present invention shows property of high recovery of valuable metals although its small energy input and pollutant loading.

In contrast, physical separation method can be hardly applied to the real industrial field because it is almost impossible to recover valuable metals. Otherwise, hydrometallurgical method has an advantage of high recovery of valuable metals, but has very heavy economic and environmental burden caused by large pollutant loadings due to excessive wastewater production.

1. A method of leaching products gained after crushing and grinding of laterite ores which comprises:
(a) step of crushing the ores into about 3 mm particles by using a jaw crusher and a cone crusher;
(b) step of grinding the 3 mm particles in a mill for a certain time after size separation of the 3 mm particles to form disintegrated particles; and
(c) step of stirring and leaching the disintegrated particles after acid application, leaching nickel and magnesium from laterite ores, wherein the acid is any one of 0.5N hydrochloric acid or 0.5N sulfuric acid.

2. The method of leaching nickel and magnesium from laterite ores according to claim 1, in which the mill is any one of a planetary, vibrating, or ball mill.

3. (canceled)

4. The method of leaching nickel and magnesium from laterite ores according to claim 1, in which leaching is done for 1 hour.

5. A method of leaching products gained after crushing and grinding of laterite ores which comprises:
crushing the ores into about 3 mm particles by using a jaw crusher and a cone crusher;
grinding the 3 mm particles in a mill for a certain time after size separation of the 3 mm particles to form disintegrated particles; and
stirring and leaching the disintegrated particles after acid application, leaching nickel and magnesium from laterite ores at room temperature.

6. A method of leaching products gained after crushing and grinding of laterite ores which comprises:
crushing the ores into about 3 mm particles by using a jaw crusher and a cone crusher;
grinding the 3 mm particles in a mill for a certain time after size separation of the 3 mm particles to form disintegrated particles; and
stirring and leaching the disintegrated particles after acid application, leaching nickel and magnesium from laterite ores without heating.
